(19) United States
(12) Patent Application Publication
(10) Pub. No.: US 2026/0188577 A1
(43) Pub. Date: Jul. 2, 2026

(54) MULTILAYER CERAMIC CAPACITOR AND METHOD OF MANUFACTURING THE SAME

(71) Applicant: SAMSUNG ELECTRO-MECHANICS CO., LTD., Suwon-si (KR)

(72) Inventors: Dong Ju Han, Suwon-si (KR); Jeong Ryeol Kim, Suwon-si (KR); Sunho Yoon, Suwon-si (KR); Jeongah Jeong, Suwon-si (KR)

(73) Assignee: SAMSUNG ELECTRO-MECHANICS CO., LTD., Suwon-si (KR)

(21) Appl. No.: 19/282,634

(22) Filed: Jul. 28, 2025

(30) Foreign Application Priority Data
Dec. 26, 2024 (KR) 10-2024-0196577

(51) Int. Cl. H01G 4/008; H01G 4/012; H01G 4/12; H01G 4/30

(52) U.S. Cl. CPC H01G 4/008; H01G 4/012; H01G 4/1209; H01G 4/30

(57) ABSTRACT

A multilayer ceramic capacitor including a capacitor body including a dielectric layer and an internal electrode layer. The capacitor body includes an active region, and margin regions disposed on opposite sides of the active region in a direction perpendicular to a stacking direction. The active region is divided into three portions in the stacking direction and has a central portion and surface portions located on both surfaces of the central portion. The internal electrode layer includes an internal electrode layer interface region, and the dielectric layer includes a dielectric layer interface region. At least one of the internal electrode layer interface region and the dielectric layer interface region located in the central portion of the active region includes sulfur (S). At least one of the internal electrode layer interface region and the dielectric layer interface region located in at least one of the surface portions includes sulfur (S).

### CROSS-REFERENCE TO RELATED APPLICATION

This application claims priority to and the benefit of Korean Patent Application No. 10-2024-0196577 filed with the Korean Intellectual Property Office on Dec. 26, 2024, the entire contents of which are incorporated herein by reference.

### BACKGROUND

### (a) Technical Field

The present disclosure relates to a multilayer ceramic capacitor and a manufacturing method thereof.

### (b) Description of the Related Art

As electronic components using a ceramic material, there are a capacitor, an inductor, a piezoelectric element, a varistor, a thermistor, and the like. Among ceramic electronic components, a multilayer ceramic capacitor (MLCC) may be used in various electronic devices due to advantages such as a small size, a high capacitance, an easy mounting feature, and the like.

For example, a multilayer ceramic capacitor (MLCC) may be used in a chip type condenser mounted on a board of several electronic products such as image devices, for example, liquid crystal displays (LCD), plasma display panels (PDP), or the like, computers, personal portable terminals, smartphones, and the like, to serve to charge or discharge electricity therein or therefrom.

Recently, with the development of electronic devices and autonomous vehicles, there is a growing demand for miniaturization and larger capacity of multilayer ceramic capacitors. In order to achieve higher capacitance in the same volume, thinning of a dielectric layer and an internal electrode layer is essential. To this end, research is being conducted on atomization and shrinkage behavior control of nickel (Ni) material in the internal electrode layer.

### SUMMARY

An embodiment provides a multilayer ceramic capacitor having excellent electrical characteristics and reliability.

Another embodiment provides a method of manufacturing a multilayer ceramic capacitor.

An embodiment provides a multilayer capacitor including a capacitor body including a dielectric layer and an internal electrode layer, and an external electrode disposed on an outer surface of the capacitor body, wherein the capacitor body includes an active region in which the dielectric layer and the internal electrode layer are stacked in a stacking direction, and a margin region disposed on sides of the active region opposing each other in a direction perpendicular to the stacking direction, the active region includes three portions in the stacking direction, the three portions include a central portion, and a surface portion located on both surfaces of the central portion, and the internal electrode layer includes an internal electrode layer interface region including an interface with the dielectric layer, and the dielectric layer comprises a dielectric layer interface region including an interface with the internal electrode layer, and wherein at least one of the internal electrode layer interface region or the dielectric layer interface region located in the central portion of the active region includes sulfur (S), and at least one of the internal electrode layer interface region or the dielectric layer interface region located in at least one of i) the surface portion of the active region or ii) the margin region includes sulfur (S).

The at least one of the internal electrode layer interface region or the dielectric layer interface region located in the central portion of the active region may include the sulfur (S) in an amount of about 0.1 mol % or more and less than about 2.0 mol % based on a total amount of elements present in each corresponding region in the central portion of the active region.

The at least one of the internal electrode layer interface region or the dielectric layer interface region located in the central portion of the active region may further include nickel (Ni), and in a transmission electron microscope-energy dispersive spectroscopy (TEM-EDS) line analysis of a straight section from a point of the internal electrode layer to a point of the dielectric layer adjacent to the internal electrode layer in the central portion of the active region, the internal electrode layer interface region in the central portion of the active region may be a region from a point that is about ½ of a maximum mol % of nickel (Ni) to a point that is about 9/10 of the maximum mol % of nickel (Ni) based on a total amount of elements present in the same region.

The at least one of the internal electrode layer interface region or the dielectric layer interface region located in the central portion of the active region may further include nickel (Ni), and in a transmission electron microscope-energy dispersive spectroscopy (TEM-EDS) line analysis of a straight section from a point of the internal electrode layer to a point of the dielectric layer adjacent to the internal electrode layer in the central portion of the active region, the dielectric layer interface region in the central portion of the active region may be a region from a point that is about ½ of a maximum mol % of nickel (Ni) to a point that is about ¼ of the maximum mol % of nickel (Ni) based on a total amount of elements present in the same region.

The at least one of the internal electrode layer interface region or the dielectric layer interface region located in the central portion of the active region may include the sulfur (S) in an amount of about 0.1 mol % to about 1.2 mol % based on a total amount of elements present in each corresponding region in the central portion of the active region.

The at least one of the internal electrode layer interface region or the dielectric layer interface region located in at least one of i) the surface portion of the active region or ii) the margin region may include the sulfur (S) in an amount of more than about 0 mol % and about 1.0 mol % or less based on a total amount of elements present in each corresponding region in the at least one of the surface portion of the active region or the margin region.

The at least one of the internal electrode layer interface region or the dielectric layer interface region located in at least one of i) the surface portion of the active region or ii) the margin region may further include nickel (Ni), and in a transmission electron microscope-energy dispersive spectroscopy (TEM-EDS) line analysis of a straight section from a point of the internal electrode layer to a point of the dielectric layer adjacent to the internal electrode layer in at least one of the surface portion of the active region or the margin region, the internal electrode layer interface region in at least one of the surface portions of the active region or the margin region may be a region from a point that is about ½ of a maximum mol % of nickel (Ni) to a point that is about 9/10 of the maximum mol % of nickel (Ni) based on a total amount of elements present in the same region.

The at least one of the internal electrode layer interface region or the dielectric layer interface region located in at least one of i) the surface portion of the active region or ii) the margin region may further include nickel (Ni), and in a transmission electron microscope-energy dispersive spectroscopy (TEM-EDS) line analysis of a straight section from a point of the internal electrode layer to a point of the dielectric layer adjacent to the internal electrode layer in at least one of the surface portion of the active region or the margin region, the dielectric layer interface region in at least one of the surface portion of the active region or the margin region may be a region from a point that is about ½ of a maximum mol % of nickel (Ni) to a point that is about 1/10 of the maximum mol % of nickel (Ni) based on a total amount of elements present in the same region.

Another embodiment provides a multilayer ceramic capacitor including a capacitor body including a dielectric layer and an internal electrode layer, and an external electrode disposed on an outer surface of the capacitor body, wherein the capacitor body includes an active region in which the dielectric layer and the internal electrode layer are stacked in a stacking direction, and a margin region disposed on sides of the active region opposing each other in a direction perpendicular to the stacking direction, the active region includes three portions in the stacking direction, the three portions include a central portion and a surface portion located on both surfaces of the central portion, and wherein in the central portion of the active region, at least one of (i) a first region from an interface between the internal electrode layer and the dielectric layer to a depth of about 15 nm to about 25 nm from the interface into an interior of the internal electrode layer, or (ii) a second region from the interface to a depth of about 15 nm to about 25 nm from the interface into an interior of the dielectric layer includes sulfur (S), and in at least one of the surface portion of the active region or the margin region, at least one of (i) a third region from the interface to a depth of about 5 nm to about 15 nm from the interface into the interior of the internal electrode layer, or (ii) a fourth region from the interface to a depth of about 5 nm to about 15 nm from the interface into the interior of the dielectric layer includes sulfur (S).

In the central portion of the active region, at least one of the first region or the second region may include the sulfur (S) in an amount of about 0.1 mol % or more and less than about 2.0 mol % based on a total amount of elements present in each corresponding region.

In the central portion of the active region, at least one of the first region or the second region may include the sulfur (S) in an amount of about 0.1 mol % to about 1.2 mol % based on a total amount of elements present in each corresponding region.

In at least one of the surface portion of the active region or the margin region, at least one of a third region or the fourth region may include the sulfur (S) in an amount of more than about 0 mol % and about 1.0 mol % or less based on a total amount of elements present in each corresponding region.

An embodiment provides a method of manufacturing the multilayer ceramic capacitor which includes: preparing a conductive paste using a sulfur-containing nickel; manufacturing a plurality of dielectric green sheets from a dielectric slurry and printing the conductive paste on a surface of the plurality of dielectric green sheets to form a conductive paste layer; manufacturing a dielectric green sheet stack by stacking the plurality of dielectric green sheets on which the conductive paste layer is formed; performing a heat treatment on the dielectric green sheet stack to desulfurize the sulfur-containing nickel; manufacturing the capacitor body by firing the dielectric green sheet stack after the heat treatment; and forming the external electrode on the outer surface of the capacitor body.

The sulfur-containing nickel may have a form in which sulfur (S) is coated on the surface of nickel (Ni).

The sulfur-containing nickel may include about 100 ppm to about 2000 ppm of sulfur (S).

The heat treatment may be performed at a temperature of about 900° C. to about 1500° C.

The heat treatment may be performed for about 0.01 hours to about 2.0 hours.

An embodiment provides a multilayer capacitor including a capacitor body including a dielectric layer and an internal electrode layer, and an external electrode disposed on an outer surface of the capacitor body, wherein the capacitor body includes an active region in which the dielectric layer and the internal electrode layer are stacked in a stacking direction, and a margin region disposed on sides of the active region opposing each other in a direction perpendicular to the stacking direction, the active region includes three portions in the stacking direction, the three portions include a central portion, and a surface portion located on both surfaces of the central portion, and the dielectric layer comprises a dielectric layer interface region including an interface with the internal electrode layer, and wherein (i) the dielectric layer interface region located in the central portion of the active region includes sulfur (S), (ii) the dielectric layer interface region located in at least one of the surface portion of the active region or the margin region includes sulfur (S), or both (i) and (ii).

The dielectric layer interface region located in the central portion of the active region may include the sulfur (S) in an amount of about 0.1 mol % or more and less than about 2.0 mol % based on a total amount of elements present in the same region.

The dielectric layer interface region located in the central portion of the active region may further include nickel (Ni), and in a transmission electron microscope-energy dispersive spectroscopy (TEM-EDS) line analysis of a straight section from a point of the internal electrode layer to a point of the dielectric layer adjacent to the internal electrode layer in the central portion of the active region, the dielectric layer interface region in the central portion of the active region may be a region from a point that is about ½ of a maximum mol % of nickel (Ni) to a point that is about ¼ of the maximum mol % of nickel (Ni) based on a total amount of elements present in the same region.

The dielectric layer interface region located in the central portion of the active region may further include nickel (Ni), and in a transmission electron microscope-energy dispersive spectroscopy (TEM-EDS) line analysis of a straight section from a point of the internal electrode layer to a point of the dielectric layer adjacent to the internal electrode layer in the central portion of the active region, the dielectric layer interface region in the central portion of the active region may be a region from a point that is about ½ of a maximum mol % of nickel (Ni) to a point that is about 1/10 of the maximum mol % of nickel (Ni) based on a total amount of elements present in the same region.

The multilayer ceramic capacitor according to an embodiment can have excellent connectivity of internal electrode layers, and have excellent electrical characteristics and reliability.

### BRIEF DESCRIPTION OF THE DRAWINGS

FIG. 1 is a perspective view showing a multilayer ceramic capacitor according to an embodiment.

FIG. 2 is a cross-sectional view of the multilayer ceramic capacitor taken along line I-I′ of FIG. 1.

FIG. 3 is a cross-sectional view of the multilayer ceramic capacitor taken along line II-II′ of FIG. 1.

FIG. 4 is an exploded perspective view illustrating the stacked structure by disassembling the capacitor body of FIG. 1.

FIG. 5 is an enlarged view of the X region in FIG. 2.

FIG. 6 is an enlarged view of the Y region in FIG. 2.

FIGS. 7A and 7B are transmission electron microscope-energy dispersive spectroscopy (TEM-EDS) line analysis image and graph for the internal electrode layer and the dielectric layer in the central portion of the active region according to Example 1.

FIGS. 8A and 8B are transmission electron microscope-energy dispersive spectroscopy (TEM-EDS) line analysis image and graph for the internal electrode layer and the dielectric layer in the central portion of the active region according to Example 2.

FIGS. 9A and 9B are transmission electron microscope-energy dispersive spectroscopy (TEM-EDS) line analysis image and graph for the internal electrode layer and the dielectric layer in the central portion of the active region according to Example 3.

FIGS. 10A and 10B are transmission electron microscope-energy dispersive spectroscopy (TEM-EDS) line analysis image and graph for the internal electrode layer and the dielectric layer in the central portion of the active region according to Example 4.

FIGS. 11A to 11C are transmission electron microscope-energy dispersive spectroscopy (TEM-EDS) line analysis images and graph for the internal electrode layer and the dielectric layer in the margin region according to Example 1.

FIGS. 12A and 12B are TEM-EDS (transmission electron microscopy-energy dispersive spectroscopy) analysis images of the central portion of the active region according to Example 2.

### DETAILED DESCRIPTION

Hereinafter, the present disclosure will be described in detail hereinafter with reference to the accompanying drawings, in which embodiments of the present disclosure are shown. The drawings and description are to be regarded as illustrative in nature and not restrictive. Like reference numerals designate like elements throughout the specification. In the accompanying drawings, some components are exaggerated, omitted, or schematically illustrated, and the size of each component does not entirely reflect the actual size.

The accompanying drawings are intended only to facilitate an understanding of the embodiments disclosed in this specification, and it is to be understood that the technical ideas disclosed herein are not limited by the accompanying drawings and include all modifications, equivalents, or substitutions that are within the range of the ideas and technology of the present disclosure.

Although terms of “first,” “second,” and the like are used to explain various components, the components are not limited to such terms. These terms are only used to distinguish one component from another component.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be positioned above or below the reference element, and it is not necessarily referred to as being positioned “on” or “above” in a direction opposite to gravity.

Throughout the specification, the terms “comprise” or “have” are intended to specify the presence of stated features, integers, steps, operations, components, components or a combination thereof, but do not preclude the presence or addition of one or more other features, integers, steps, operations, components, components, and/or groups thereof. Therefore, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

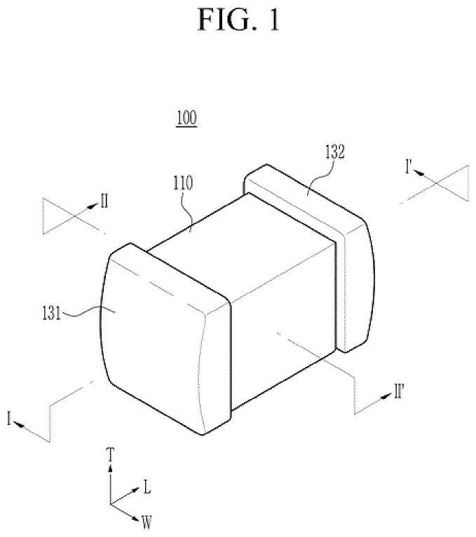

Hereinafter, a multilayer ceramic capacitor according to an embodiment will be described with reference to FIGS. 1 to 4.

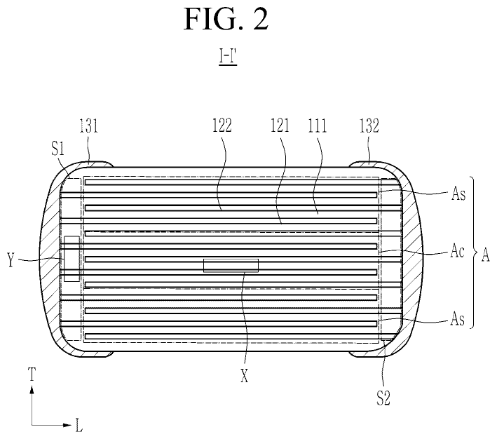

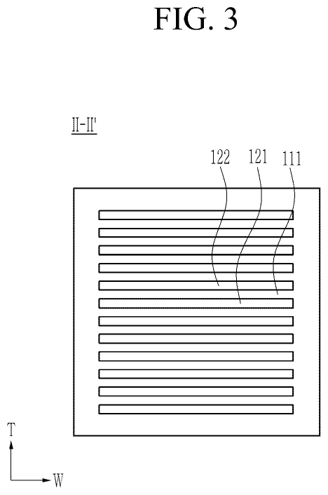

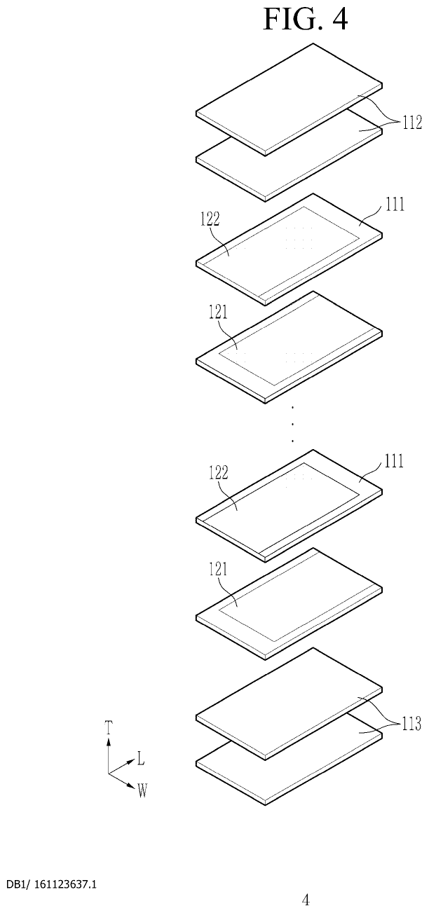

FIG. 1 is a perspective view showing a multilayer ceramic capacitor according to an embodiment, FIG. 2 is a cross-sectional view of the multilayer ceramic capacitor taken along line I-I′ of FIG. 1, FIG. 3 is a cross-sectional view of the multilayer ceramic capacitor taken along line II-II′ of FIG. 1, and FIG. 4 is an exploded perspective view illustrating the stacked structure by disassembling the capacitor body of FIG. 1.

The L-axis, W-axis, and T-axis shown in FIGS. 1 to 4 represent a length direction, a width direction, and a thickness direction of a capacitor body 110, respectively. Here, the thickness direction (T-axis direction) may be a direction perpendicular to the wide surface (major surface) of the sheet-shaped components, and may be used as the same concept as a stacking direction in which a dielectric layer 111 are stacked, for example. The length direction (L-axis direction) may be a direction extending parallel to the wide surface (major surface) of the sheet-shaped components, and may be approximately perpendicular to the thickness direction (T-axis direction). For example, the length direction (L-axis direction) may be the direction in which an external electrode 131 and a second external electrode 132 are positioned. The width direction (W-axis direction) may be a direction extending parallel to the wide surface (major surface) of the sheet-shaped components, and may be approximately perpendicular to the thickness direction (T-axis direction) and the length direction (L-axis direction). The length of the sheet-shaped components in the length direction (L-axis direction) may be longer than the length in the width direction (W-axis direction).

Referring to FIGS. 1 to 4, a multilayer ceramic capacitor according to an embodiment includes the capacitor body 110 and external electrodes 131 and 132 disposed on an outer surface of the capacitor body 110. The external electrodes 131 and 132 may include a first external electrode 131 and a second external electrode 132 disposed at opposite ends of the capacitor body 110 in the length direction (L-axis direction).

For example, the capacitor body 110 may have a roughly hexahedral shape.

For convenience of description of an embodiment, the two surfaces opposing each other in the thickness direction (T-axis direction) of the capacitor body 110 are referred to as first and second surfaces, the two surfaces connected to the first and second surfaces and opposing each other in the length direction (L-axis direction) are referred to as third and the fourth surfaces, and two surfaces connected to the first and second surfaces and to the third and fourth surfaces, and opposing each other in the width direction (W-axis direction) are referred to as the fifth and sixth surfaces.

As an example, the first surface, which is the lower surface, may be a surface facing the mounting direction. Additionally, the first to the sixth surfaces may be flat, but the embodiment is not limited thereto. For example, the first to the sixth surfaces may be curved surfaces with a convex central portion, and the edges, which are the boundaries of each surface, may be rounded.

The shape and size of the capacitor body 110 and the number of stacks of the dielectric layers 111 are not limited to those shown in the drawings of the embodiment.

The capacitor body 110 includes a plurality of dielectric layers 111 and internal electrode layers 121 and 122. Specifically, the capacitor body 110 includes the plurality of dielectric layers 111 and a first internal electrode layer 121 and a second internal electrode layer 122 alternately disposed in the thickness direction (T-axis direction) interposing the dielectric layer 111.

At this time, the boundaries between adjacent dielectric layers 111 of the capacitor body 110 may be integrated to the extent that it is difficult to check without using a scanning electron microscope (SEM).

The capacitor body 110 may include an active region A, margin regions S1 and S2, and cover regions 112 and 113.

The active region A is a region where the dielectric layer 111 and the internal electrode layers 121 and 122 are alternately stacked, which contributes to forming capacitance of the multilayer capacitor 100. Specifically, the active region A may be a region where the first internal electrode layer 121 or the second internal electrode layer 122 stacked along the thickness direction (T-axis direction) overlap.

The active region A may be divided into three equal parts in the thickness direction (T-axis direction), i.e., in the stacking direction, and may have a central portion Ac and surface portions As located on both surfaces of the central portion Ac.

The margin regions S1 and S2 may be positioned on opposite side ends of the active region A in the length direction (L-axis direction), i.e., in the direction perpendicular to the stacking direction, i.e., on the third surface and the fourth surface, respectively. The margin regions S1 and S2 may be regions where the ends of the internal electrode layers 121 and 122 that are electrically connected to the external electrodes 131 and 132 are located. Specifically, the margin region may include a first margin region S1 where an end of the first internal electrode layer 121 electrically connected to the first external electrode 131 is located, and a second margin region S2 where an end of the second internal electrode layer 122 electrically connected to the second external electrode 132 is located.

The cover regions 112 and 113 are thickness-direction marginal portions, and may be positioned on the first and second surfaces of the active region A in the thickness direction (T-axis direction), i.e., in the stacking direction, respectively. The cover regions 112 and 113 may be a single dielectric layer 111 or two or more dielectric layers 111 stacked on the upper and lower surfaces of the active region A, respectively.

Additionally, the capacitor body 110 may further include a width-direction side margin region.

The width-direction side margin region may be located on opposite side ends of the active region A in the width direction (W-axis direction), that is, on the fifth surface and the sixth surface, respectively. The width-direction side margin region may be formed according as, when a conductive paste layer for the internal electrode is applies on a surface of a dielectric green sheet, the dielectric green sheets, which are applied with the conductive paste layer only in a partial region of the surface of the dielectric green sheet and not applied with the conductive paste layer on both side surfaces of the surface of the dielectric green sheet, are stacked and then fired, but the forming method is not limited thereto.

The cover regions 112 and 113 and the width-direction side margin region serve to prevent damage to the first internal electrode layer 121 and the second internal electrode layer 122 due to physical or chemical stress.

The internal electrode layers 121 and 122, i.e., the first internal electrode layer 121 and the second internal electrode layer 122, are electrodes having different polarities and are alternately disposed to face each other along the T-axis direction with the dielectric layer 111 interposed between them, and one end may be exposed through the third and fourth surfaces of the capacitor body 110, respectively.

The first internal electrode layer 121 and the second internal electrode layer 122 may be electrically insulated from each other by a dielectric layer 111 disposed in the middle.

The ends of the first internal electrode layer 121 and the second internal electrode layer 122, which are alternately exposed through the third and fourth surfaces of the capacitor body 110, may be electrically connected to the first external electrode 131 and the second external electrode 132, respectively.

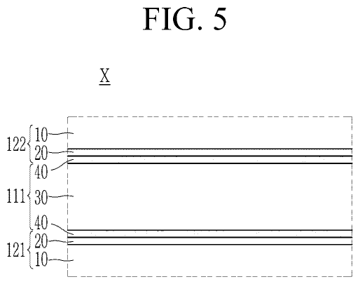

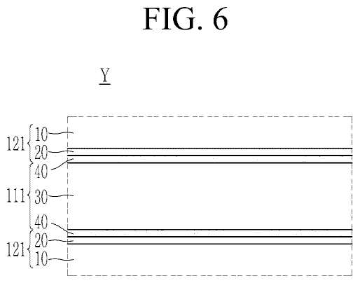

The internal electrode layers 121 and 122 and the dielectric layer 111 are explained with reference to FIGS. 5 and 6.

FIG. 5 is an enlarged view of the X region in FIG. 2, showing a portion within the active region A, specifically, a portion within the central portion Ac of the active region A. FIG. 6 is an enlarged view of the Y region in FIG. 2, showing a portion within the margin regions S1 and S2.

Referring to FIGS. 5 and 6, the internal electrode layers 121 and 122 includes an internal electrode layer inner region 10 and an internal electrode layer interface region 20 that is disposed on at least one surface of the internal electrode layer inner region 10 in the stacking direction and includes an interface with the dielectric layer 111. In addition, the dielectric layer 111 includes a dielectric layer inner region 30 and a dielectric layer interface region 40 that is disposed on at least one surface of the dielectric layer inner region 30 in the stacking direction and includes an interface with the internal electrode layers 121 and 122.

According to an embodiment, sulfur (S) may be included at an interface between the internal electrode layers 121 and 122 and the dielectric layer 111 located in the central portion Ac of the active region A. Specifically, at least one of the internal electrode layer interface region 20 and the dielectric layer interface region 40 located in the central portion Ac of the active region A may includes sulfur (S). At this time, sulfur (S) may be included in an amount of about 0.1 mol % or more and less than about 2.0 mol % based on a total amount of elements present in each corresponding region. At this time, the internal electrode layer interface region 20 in the central portion Ac of the active region A includes an interface between the internal electrode layers 121 and 122 and the dielectric layer 111, and the dielectric layer interface region 40 in the central portion Ac of the active region A includes an interface between the dielectric layer 111 and the internal electrode layers 121 and 122, and each of the interfaces may be a point that is about ½ of a maximum mol % of nickel (Ni), which is the main component of the internal electrode layers 121 and 122.

That is, the internal electrode layer interface region 20 located in the central portion Ac of the active region A may include sulfur (S) in an amount of about 0.1 mol % or more and less than about 2.0 mol % based on a total amount of elements present in the internal electrode layer interface region 20, or the dielectric layer interface region 40 located in the central portion Ac of the active region A may include sulfur (S) in an amount of about 0.1 mol % or more and less than about 2.0 mol % based on a total amount of elements present in the dielectric layer interface region 40, or both the internal electrode layer interface region 20 and the dielectric layer interface region 40 located in the central portion Ac of the active region A may include sulfur (S), and in this case, sulfur (S) may be included in an amount of about 0.1 mol % or more and less than about 2.0 mol % based on a total amount of elements present in each region.

For example, at least one of the internal electrode layer interface region 20 and the dielectric layer interface region 40 located in the central portion Ac of the active region A may include sulfur (S) in an amount of about 0.1 mol % to about 1.8 mol %, about 0.1 mol % to about 1.5 mol %, or about 0.1 mol % to about 1.2 mol % based on a total amount of elements present in each corresponding region.

Sulfur (S) can be derived from a sulfur-containing nickel used as a main material in forming the internal electrode layers 121 and 122. That is, the sulfur-containing nickel can have a form in which sulfur (S) is coated on a surface of nickel (Ni). According to an embodiment, by controlling the content of sulfur (S) through a desulfurization process of the sulfur-containing nickel before firing during manufacturing a multilayer ceramic capacitor, a multilayer ceramic capacitor having controlled sulfur (S) content at an interface between an internal electrode layer and a dielectric layer can be obtained. Controlling the sulfur (S) content in the manufacture of the multilayer ceramic capacitor can be performed by changing heat treatment conditions of the desulfurization process.

The sulfur-containing nickel has an effect of delaying Ni shrinkage in the early stage of firing due to sulfur (S) present on a surface of nickel (Ni), but SO₂ decomposition occurs in the high temperature section above 850° C., and rapid shrinkage occurs due to Ni surface expose. In this way, if sulfur (S), which causes rapid shrinkage in the high-temperature firing section, is removed through a desulfurization process before firing, the sulfur (S) content at the interface between the internal electrode layers 121 and 122 and the dielectric layer 111 can be reduced to the predetermined range described above.

Accordingly, when the sulfur (S) content at the interface between the internal electrode layers 121 and 122 and the dielectric layer 111 is controlled to the above range according to an embodiment, that is, when at least one of the internal electrode layer interface region 20 and the dielectric layer interface region 40 in the central portion Ac of the active region A includes sulfur (S) in an amount of about 0.1 mol % or more and less than about 2.0 mol %, the shrinkage behavior of Ni changes, thereby improving the microstructures of the internal electrode layer and the dielectric layer, thereby improving the connectivity and electrical characteristics of the internal electrode layers. Specifically, when sulfur (S) is included in the above region in an amount of about 2.0 mol % or more, rapid shrinkage of Ni occurs in the high-temperature firing section, which deteriorates the microstructural characteristics of the internal electrode layer and the dielectric layer, resulting in reduced connectivity of the internal electrode layer, reduced capacity characteristics, and degradation of the breakdown voltage (BDV), which may result in reduced reliability. In addition, when sulfur (S) is included in the above region in an amount of less than about 0.1 mol %, the microstructural characteristics of the internal electrode layer may deteriorate because an excessive heat treatment process is required to completely remove sulfur.

According to an embodiment, sulfur (S) may be included in the interface between the internal electrode layers 121 and 122 and the dielectric layer 111, specifically, in at least one of the internal electrode layer interface region 20 and the dielectric layer interface region 40, located not only in the central portion Ac of the active region A, but also in at least one of the surface portions As of the active region A and the margin regions S1 and S2.

At least one of the internal electrode layer interface region 20 and the dielectric layer interface region 40 located in at least one of i) the surface portions As of the active region A and ii) the margin regions S1 and S2 may include sulfur (S) in an amount of more than about 0 mol % and about 1.0 mol % or less based on a total amount of elements present in each corresponding region. At this time, the internal electrode layer interface region 20 in at least one of the surface portions As of the active region A and the margin regions S1 and S2 includes an interface between the internal electrode layers 121 and 122 and the dielectric layer 111, and the dielectric layer interface region 40 in at least one of the surface portions As of the active region A and the margin region S1 and S2 includes an interface between the dielectric layer 111 and the internal electrode layers 121 and 122, and each of the interfaces may be a point that is about ½ of the maximum mol % of nickel (Ni), which is the main component of the internal electrode layers 121 and 122.

That is, the internal electrode layer interface region 20 located in at least one of i) the surface portions As of the active region A and ii) the margin regions S1 and S2 includes sulfur (S) in an amount of more than about 0 mol % and about 1.0 mol % or less based on a total amount of elements present in the internal electrode layer interface region 20, or the dielectric layer interface region 40 located in at least one of i) the surface portions As of the active region A and ii) the margin regions S1 and S2 includes sulfur (S) in an amount of more than about 0 mol % and about 1.0 mol % or less based on a total amount of elements present in the dielectric layer interface region 40, or both the internal electrode layer interface region 20 and the dielectric layer interface region 40 located in at least one of i) the surface portions As of the active region A and ii) the margin regions S1 and S2 include sulfur (S), and in this case, sulfur (S) may be included in an amount of more than about 0 mol % and about 1.0 mol % or less based on a total amount of elements present in each region.

When sulfur (S) is included in an amount of more than about 0 mol % and about 1.0 mol % or less in at least one of the internal electrode layer interface region 20 and the dielectric layer interface region 40 located in at least one of i) the surface portions As of the active region A and ii) the margin regions S1 and S2, the shrinkage behavior of Ni changes, thereby improving the microstructural characteristics of the internal electrode layer and the dielectric layer, thereby improving the connectivity and electrical characteristics of the internal electrode layer.

For example, at least one of the internal electrode layer interface region 20 and the dielectric layer interface region 40 located in at least one of i) the surface portions As of the active region A and ii) the margin regions S1 and S2 may include sulfur (S) in an amount of about 0.01 mol % to about 0.8 mol %, about 0.01 mol % to about 0.6 mol %, or about 0.01 mol % to about 0.4 mol % based on a total amount of elements present in each corresponding region.

In this way, according to an embodiment, the sulfur (S) content at the interface between the internal electrode layers 121 and 122 and the dielectric layer 111 may vary depending on the location within the capacitor body 110. That is, the sulfur (S) content at the interface may be different in at least one of i) the surface portions As of the active region A and ii) the margin regions S1 and S2 from that in the central portion Ac of the active region A. Accordingly, the microstructural characteristics of the internal electrode layer and the dielectric layer can be improved, the connectivity of the internal electrode layer can be enhanced, and the electrical characteristics and reliability can be improved.

At least one of the internal electrode layer interface region 20 and the dielectric layer interface region 40 located in the central portion Ac of the active region A may further include nickel (Ni) in addition to sulfur (S). In addition, at least one of the internal electrode layer interface region 20 and the dielectric layer interface region 40 located in at least one of i) the surface portions As of the active region A and ii) the margin regions S1 and S2 may further include nickel (Ni) in addition to sulfur (S).

The composition and content of sulfur (S) at the interface between the internal electrode layers 121 and 122 and the dielectric layer 111 can be confirmed through a transmission electron microscope-energy dispersive spectroscopy (TEM-EDS) analysis. Other methods and/or tools appreciated by one of ordinary skill in the art, even if not described in the present disclosure, may also be used.

The TEM-EDS analysis can be performed by the following methods.

After the multilayer ceramic capacitor 100 is placed into an epoxy mixing solution and then cured, the L-axis and the T-axis directional surface (LT surface) of the capacitor body 110 is polished to ½ depth in the W-axis direction to expose a LT cross-section. A cross-sectional sample C, for observing the active region A where the dielectric layer 111 and the internal electrode layers 121 and 122 overlap in the exposed LT cross-section, and a cross-sectional sample S, for observing the margin regions S1 and S2 located at ends of the active region A in the L-axis direction (perpendicular to the stacking direction), are each obtained. Next, when the active region A of the cross-sectional sample C is divided into three parts in the T-axis direction (stacking direction), the outer surface portions As and the central portion Ac located therebetween, each portion is measured by TEM under conditions of an acceleration voltage of 200 kV and a magnification of 10 k to 100 k so that at least one dielectric layer 111 and at least one internal electrode layers 121 and 122 are visible. In addition, the margin regions S1 and S2 of the cross-sectional sample S are measured by TEM under conditions of an acceleration voltage of 200 kV and a magnification of 10 k to 100 k so that at least one dielectric layer 111 and at least one internal electrode layers 121 and 122 are visible.

Next, by performing EDS analysis on each TEM image of the cross-sectional sample, the components present at the interface between the dielectric layer 111 and the internal electrode layers 121 and 122 in each region can be confirmed.

In addition, by performing EDS line analysis on a straight section from a point of the internal electrode layers 121 and 122 to a point of the dielectric layer 111 adjacent to the internal electrode layers 121 and 122 in each TEM image of cross-sectional sample C and the TEM image of cross-sectional sample S, it is possible to confirm the contents of components at the interface between the internal electrode layers 121 and 122 and the dielectric layer 111 located in the central portion Ac and the surface portions As of the active region A, respectively, and the contents of components at the interface between the internal electrode layers 121 and 122 and the dielectric layer 111 located in the margin regions S1 and S2.

For example, the component content measured at the central portion Ac of the active region A can be obtained as the average value of the component content at a total of nine points by selecting three different sets of internal electrode layers and dielectric layer at the central portion of the active region, and designating three random points within the interface between the internal electrode layers and the dielectric layer for each set of internal electrode layers and dielectric layer. In addition, for example, the component content measured in the margin regions S1 and S2 can be obtained as the average value of the S content at a total of 9 points by selecting three different sets of internal electrode layers and dielectric layer in the margin region, and designating three random points within the interface between the internal electrode layers and the dielectric layer for each set of internal electrode layers and dielectric layer.

In addition, through the EDS line analysis, the internal electrode layer interface region 20 and the dielectric layer interface region 40 in the central portion Ac and the surface portions As of the active region A and the margin regions S1 and S2, respectively, can be confirmed.

For example, in the TEM-EDS line analysis of a straight section from a point of the internal electrode layers 121 and 122 to a point of the dielectric layer 111 adjacent to the internal electrode layers 121 and 122 in the central portion Ac of the active region A, the internal electrode layer interface region 20 in the central portion Ac of the active region A can be defined as a region from a point that is about ½ of the maximum mol % of nickel (Ni) to a point that is about 9/10 of the maximum mol % of nickel (Ni) based on a total amount of elements present in the same region, and the dielectric layer interface region 40 in the central portion Ac of the active region A can be defined as a region from a point that is about ½ of the maximum mol % of nickel (Ni) to a point that is about ¼ of the maximum mol % of nickel (Ni) based on a total amount of elements present in the same region.

For example, the internal electrode layer interface region 20 in the central portion Ac of the active region A may be a region (e.g., first region) from the interface between the internal electrode layers 121 and 122 and the dielectric layer 111, for example from a point that is about ½ of the maximum mol % of nickel (Ni), to a depth of about 15 nm to about 25 nm from the interface, for example, a depth of about 20 nm from the interface into the interior of the internal electrode layers 121 and 122, and the dielectric layer interface region 40 in the central portion Ac of the active region A may be a region (e.g., second region) from the interface between the dielectric layer 111 and the internal electrode layers 121 and 122, for example from a point that is about ½ of the maximum mol % of nickel (Ni), to a depth of about 15 nm to about 25 nm from the interface, for example, a depth of about 20 nm from the interface into the interior of the dielectric layer 111.

In addition, from the TEM-EDS line analysis, the internal electrode layer inner region 10 and the internal electrode layer interface region 20 can be distinguished from each other based on a point that is about 9/10 of the maximum mol % of nickel (Ni), and the dielectric layer inner region 30 and the dielectric layer interface region 40 can be distinguished from each other based on a point that is about ¼ of the maximum mol % of nickel (Ni).

As another example, when analyzing the TEM-EDS line for a straight section from a point of the internal electrode layers 121 and 122 to a point of the dielectric layer 111 adjacent to the internal electrode layers 121 and 122 in at least one of the surface portions As of the active region A and the margin regions S1 and S2, the internal electrode layer interface region 20 in at least one of the surface portions As of the active region A and the margin regions S1 and S2 can be defined as a region from a point that is about ½ of the maximum mol % of nickel (Ni) to a point that is about 9/10 of the maximum mol % of nickel (Ni) based on a total amount of elements present in the same region, and the dielectric layer interface region 40 in at least one of the surface portions As of the active region A and the margin regions S1 and S2 can be defined as a region from a point that is about ½ of the maximum mol % of nickel (Ni) to a point that is about 1/10 of the maximum mol % of nickel (Ni) based on a total amount of elements present in the same region.

For example, the internal electrode layer interface region 20 in at least one of the surface portions As of the active region A and the margin regions S1 and S2 may be a region (e.g., third region) from the interface between the internal electrode layers 121 and 122 and the dielectric layer 111, for example from a point that is about ½ of the maximum mol % of nickel (Ni), to a depth of about 5 nm to about 15 nm from the interface, for example, a depth of about 10 nm from the interface into the interior of the internal electrode layers 121 and 122, and the dielectric layer interface region 40 in at least one of the surface portions As of the active region A and the margin regions S1 and S2 may be a region (e.g., fourth region) from the interface between the dielectric layer 111 and the internal electrode layers 121 and 122, for example from a point that is about ½ of the maximum mol % of nickel (Ni), to a depth of about 5 nm to about 15 nm from the interface, for example, a depth of about 10 nm from the interface into the interior of the dielectric layer 111.

In addition, from the TEM-EDS line analysis, the internal electrode layer inner region 10 and the internal electrode layer interface region 20 can be distinguished from each other based on a point that is about 9/10 of the maximum mol % of nickel (Ni), and the dielectric layer inner region 30 and the dielectric layer interface region 40 can be distinguished from each other based on a point that is about 1/10 of the maximum mol % of nickel (Ni).

In addition to the sulfur-containing nickel, the internal electrode layers 121 and 122 may further include one or more conductive metals selected from copper (Cu), silver (Ag), palladium (Pd), gold (Au), and alloys thereof.

The internal electrode layers 121 and 122 can be formed using a conductive paste including the sulfur-containing nickel. The printing method for the conductive paste can be either screen printing or gravure printing.

Each average thickness of the first internal electrode layer 121 and the second internal electrode layer 122 may be about 0.1 μm to about 2 μm.

The average thickness of the first internal electrode layer 121 and the second internal electrode layer 122 may be measured by a scanning electron microscope (SEM) analysis. Specifically, the average thickness of the first internal electrode layer 121 and the second internal electrode layer 122 may be measured by placing the multilayer ceramic capacitor 100 in an epoxy mixing solution, curing it, polishing it, and then ion milling it, and then analyzing it using a scanning electron microscope (SEM). The scanning electron microscope can be measured under conditions of, for example, 10 kV and a magnification of 100 times, and can be measured so that at least 1 layer, 3 layers, 5 layers, or 10 layers of the internal electrode layers 121 and 122 are visible in the active region where the dielectric layer 111 and the internal electrode layers 121 and 122 overlap. The average thickness of the internal electrode layers can be obtained by taking the central point of the length direction (L-axis direction) or width direction (W-axis direction) of each of the internal electrode layers 121 and 122 as a reference point in the scanning electron microscope (SEM) image, and taking the mean value of the thickness of each of the internal electrode layers 121 and 122 at 10 points spaced apart from the reference point at a predetermined interval. The intervals of the 10 points may be adjusted depending on the scale of the SEM image, and may be, for example, about 1 μm to about 100 μm, about 1 μm to about 50 μm, or about 1 μm to about 10 μm. At this time, all 10 points must be positioned within each of the internal electrode layers 121 and 122, and if all 10 points are not positioned within each of the internal electrode layers 121 and 122, the position of the reference point may be changed, or the interval between the 10 points may be adjusted. In addition, by extending this average value measurement to 10 internal electrode layers and measuring the average value, the average thickness of the internal electrode layers can be more generalized.

The dielectric layer 111 may include a barium titanate-based compound including barium (Ba) and titanium (Ti) as a main component.

The barium titanate-based compound is a dielectric base material, has a high dielectric constant, and contributes to forming the dielectric constant of a multilayer ceramic capacitor 100.

For example, the barium titanate-based compound may include at least one selected from BaTiO₃, Ba(Ti, Zr)O₃, Ba(Ti, Sn)O₃, (Ba, Ca)TiO₃, (Ba, Ca)(Ti, Zr)O₃, (Ba, Ca)(Ti, Sn)O₃, (Ba, Sr)TiO₃, (Ba, Sr)(Ti, Zr)O₃ and (Ba, Sr)(Ti, Sn)O₃.

The dielectric layer 111 may further include subcomponent. The subcomponent may further include one or more selected from, for example, manganese (Mn), chromium (Cr), silicon (Si), aluminum (Al), magnesium (Mg), tin (Sn), antimony (Sb), gallium (Ga), indium (In), barium (Ba), lanthanum (La), yttrium (Y), actinium (Ac), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), and vanadium (V).

An average thickness (average length in the T-axis direction) of the dielectric layer 111 may be about 0.2 μm to about 10 μm, and for example, may be about 0.2 μm to about 8.0 μm. When the average thickness of the dielectric layer 111 is within the above range, the reliability of the multilayer ceramic capacitor may be improved.

The average thickness of the dielectric layer 111 can be measured by a scanning electron microscope (SEM) analysis. Specifically, the average thickness of the dielectric layer 111 may be measured by placing the multilayer ceramic capacitor 100 in an epoxy mixing solution, curing it, polishing it, and then ion milling it, and then analyzing it using a scanning electron microscope (SEM). The scanning electron microscope can be measured under conditions of, for example, 10 kV and a magnification of 100 times, and can be measured so that at least 1 layer, 3 layers, 5 layers, or 10 layers of the dielectric layer 111 are visible in the active region where the dielectric layer 111 and the internal electrode layers 121 and 122 overlap. The average thickness of the dielectric layer can be obtained by taking the central point of the length direction (L-axis direction) or width direction (W-axis direction) of the dielectric layer 111 as a reference point in the scanning electron microscope (SEM) image, and taking the mean value of the thickness of the dielectric layer 111 at 10 points spaced apart from the reference point at a predetermined interval. The intervals of the 10 points may be adjusted depending on the scale of the SEM image, and may be, for example, about 1 μm to about 100 μm, about 1 μm to about 50 μm, or about 1 μm to about 10 μm. At this time, all 10 points must be positioned within the dielectric layer 111, and if all 10 points are not positioned within the dielectric layer 111, the position of the reference point may be changed, or the interval between the 10 points may be adjusted. In addition, by extending this average value measurement to 10 dielectric layers and measuring the average value, the average thickness of the dielectric layer can be more generalized.

The capacitor body 110 may be formed by firing a stacking structure in which the plurality of dielectric layers 111 and internal electrode layers 121 and 122 are stacked.

The external electrodes 131 and 132, i.e., the first external electrode 131 and the second external electrode 132 are provided with voltages of different polarities and may be electrically connected with exposed portions of the first internal electrode layer 121 and the second internal electrode layer 122, respectively.

According to the above configuration, when a predetermined voltage is applied to the first external electrode 131 and the second external electrode 132, charges are accumulated between the first internal electrode layer 121 and the second internal electrode layer 122 facing each other. At this time, the capacitance of the multilayer capacitor 100 is proportional to the overlapping area of the first internal electrode layer 121 and the second internal electrode layer 122 that overlap each other along the T-axis direction in the active region.

The first external electrode 131 and the second external electrode 132 may include, respectively, first and second connection portions disposed on the third and fourth surfaces of the capacitor body 110 and connected to the first internal electrode layer 121 and the second internal electrode layer 122, and first and second band portions disposed on edges where the third and fourth surfaces of the capacitor body 110 meet the first and second surfaces or the fifth and sixth surfaces.

The first and second band portions may extend, respectively, from the first and second connection portions to portions of the first and second surfaces or the fifth and sixth surfaces of the capacitor body 110. The first and second band portions may serve to improve the adhesion strength of the first external electrode 131 and the second external electrode 132.

The external electrodes 131 and 132 may include a sintered metal layer in contact with the capacitor body 110, a conductive resin layer disposed to cover the sintered metal layer, and a plating layer disposed to cover the conductive resin layer.

The sintered metal layer may include a conductive metal and glass.

The conductive metal may include one or more selected from copper (Cu), nickel (Ni), silver (Ag), palladium (Pd), gold (Au), platinum (Pt), tin (Sn), tungsten (W), titanium (Ti), lead (Pb), and an alloy thereof, and for example, the term copper (Cu) may include a copper (Cu) alloy. When the conductive metal includes copper (Cu), metals other than copper (Cu) may be included in an amount of less than or equal to about 5 parts by mole based on 100 parts by mole of copper (Cu).

The glass may include a composition of mixed oxides, for example, one or more selected from the group consisting of silicon oxide, boron oxide, aluminum oxide, transition metal oxide, alkali metal oxide, and alkaline earth metal oxide. The transition metal may be selected from a group consisting of zinc (Zn), titanium (Ti), copper (Cu), vanadium (V), manganese (Mn), iron (Fe) and nickel (Ni), the alkali metal may be selected from a group consisting of lithium (Li), sodium (Na) and potassium (K), and the alkaline-earth metal may be at least one selected from a group consisting of magnesium (Mg), calcium (Ca), strontium (Sr) and barium (Ba).

Optionally, the conductive resin layer may be formed on the sintered metal layer, and for example, may be formed in the shape that completely covers the sintered metal layer. Meanwhile, the external electrodes 131 and 132 may not include the sintered metal layer, and in this case, the conductive resin layer may directly contact the capacitor body 110.

The conductive resin layer extends to the first and second surfaces or the fifth and sixth surfaces of the capacitor body 110, and the length of the region (i.e., band portion) where the conductive resin layer is extended and disposed to the first and second surfaces or the fifth and sixth surfaces of the capacitor body 110 may be longer than the length of the region (i.e., band portion) where the sintered metal layer is extended and disposed to the first and second surfaces or the fifth and sixth surfaces of the capacitor body 110. That is, the conductive resin layer may be formed on the sintered metal layer, and may be formed in the shape that completely covers the sintered metal layer.

The conductive resin layer may include a resin and a conductive metal.

The resin included in the conductive resin layer may be implemented by a material which has adhesive properties and shock absorption properties and is able to form a paste when mixed with the conductive metal powder, but is not limited thereto. For example, the resin may include a phenolic resin, an acrylic resin, a silicone resin, an epoxy resin, or a polyimide resin.

The conductive metal included in the conductive resin layer serves to be electrically connected to the internal electrode layers 121 and 122 or the sintered metal layer.

The conductive metal included in the conductive resin layer may have a spherical shape, a flake shape, or a combination thereof. That is, the conductive metal may be formed only in flake form, only in spherical form, or in a mixed form of flake form and spherical form.

Here, the spherical shape may also include a shape that is not a perfect spherical shape, for example, a shape in which the length ratio of the major axis and the minor axis (major axis/minor axis) is less than or equal to about 1.45. Flake shape powder refers to a powder with a flat and elongated shape, and is not particularly limited. But for example, the length ratio of the major axis and the minor axis (major axis/minor axis) may be greater than or equal to about 1.95.

The external electrodes 131 and 132 may further include the plating layer disposed outside the conductive resin layer.

The plating layer may include nickel (Ni), copper (Cu), tin (Sn), palladium (Pd), platinum (Pt), gold (Au), silver (Ag), tungsten (W), titanium (Ti), or lead (Pb), either alone or in an alloy thereof. For example, the plating layer may be a nickel (Ni) the plating layer or a tin (Sn) the plating layer, may be a form in which the nickel (Ni) the plating layer and the tin (Sn) the plating layer are sequentially stacked, or may be a form in which the tin (Sn) the plating layer, the nickel (Ni) the plating layer, and the tin (Sn) the plating layer are sequentially stacked. In addition, the plating layer may include a plurality of nickel (Ni) the plating layers and/or a plurality of tin (Sn) the plating layers.

The plating layer may improve mountability to the substrate, structural reliability, durability to the outside, heat resistance, and equivalent series resistance (ESR) of the multilayer ceramic capacitor 100.

Hereinafter, a method of manufacturing the multilayer ceramic capacitor 100 according to an embodiment will be described.

A multilayer ceramic capacitor 100 according to an embodiment may be manufactured by preparing a conductive paste using a sulfur-containing nickel; manufacturing a dielectric green sheet using a dielectric slurry and printing the conductive paste on a surface of the dielectric green sheet to form a conductive paste layer; manufacturing a dielectric green sheet stack by stacking a plurality of the dielectric green sheets on which the conductive paste layer is formed; performing a heat treatment of the dielectric green sheet stack to desulfurize the sulfur-containing nickel; manufacturing a capacitor body including a dielectric layer and an internal electrode layer by firing the dielectric green sheet stack after the heat treatment; and forming an external electrode on a surface of the capacitor body.

The sulfur-containing nickel may have a form in which sulfur (S) is coated on the surface of nickel (Ni).

The sulfur-containing nickel may include sulfur (S) in an amount of about 100 ppm to about 2000 ppm, for example about 300 ppm to about 1700 ppm, or about 500 ppm to about 1500 ppm. The amount of sulfur (S) in the sulfur-containing nickel may be determined by TEM-EDS or inductively coupled plasma mass spectrometry (ICP-MS). Other methods and/or tools appreciated by one of ordinary skill in the art, even if not described in the present disclosure, may also be used.

The heat treatment in the desulfurization step can be performed at a temperature of 900° C. to 1500° C., for example, at a temperature of 1000° C. to 1300° C., for 0.01 hour to 2.0 hours, for example, 0.1 hour to 2.0 hours. When the heat treatment is performed at the temperature and time within the above range, sulfur (S) is sufficiently removed from the sulfur-containing nickel, and the sulfur (S) content at the interface between the internal electrode layer and the dielectric layer can be controlled within a predetermined range.

The conductive paste can be prepared by mixing, in addition to the sulfur-containing nickel, one or more conductive metals selected from copper (Cu), silver (Ag), palladium (Pd), gold (Au), and alloys thereof.

Additionally, the conductive paste can be prepared by additionally mixing a conductive powder, a binder, and a solvent. Additionally, barium titanate-based powder may be mixed in as a co-material if necessary. The co-material may act to inhibit the sintering of the conductive powder during the firing process.

The dielectric slurry may be prepared by mixing a barium titanate-based compound as a main component powder and optionally a subcomponent powder. The subcomponent powder may be an oxide or salt compound, or may be used in the form of a sol dispersed in an organic solvent.

The dielectric slurry may be prepared by additionally mixing additives such as a dispersant, a binder, a plasticizer, a lubricant, an antistatic agent, and a solvent.

The dispersant may include for example at least one selected from a phosphoric acid ester-based dispersant and a polycarboxylic acid-based dispersant. The dispersant may be mixed in an amount of about 0.1 part by weight to about 5 parts by weight, for example, about 0.3 part by weight to about 3 parts by weight based on 100 parts by weight of the barium titanate-based compound. When the dispersant is mixed within the above content range, the dielectric slurry shows excellent dispersibility, and the amount of impurities included in the manufactured dielectric layer may be reduce.

The binder may be, for example, an acrylic resin, a polyvinyl butyl resin, a polyvinyl acetal resin, an ethylcellulose resin, or the like. The binder may be added in an amount of about 0.1 part by weight to about 50 parts by weight, for example, about 3 parts by weight to about 30 parts by weight, based on 100 parts by weight of the barium titanate-based compound. When the binder is mixed within the above content range, the dielectric slurry shows excellent dispersibility, and the amount of impurities included in the manufactured dielectric layer may be reduced.

The plasticizer may be, for example, a phthalic acid-based compound such as dioctyl phthalate, benzyl butyl phthalate, dibutyl phthalate, dihexyl phthalate, di(2-ethylhexyl) phthalate, and di(2-ethylbutyl) phthalate; an adipic acid-based compound such as dihexyl adipate and di(2-ethylhexyl) adipate; a glycol-based compound such as ethylene glycol, diethylene glycol, and triethylene glycol; a glycol ester-based compound such as triethylene glycol dibutyrate, triethylene glycol di(2-ethylbutyrate), and triethylene glycol di(2-ethylhexanoate); and the like. The plasticizer may be added in an amount of about 0.1 part by weight to about 20 parts by weight, for example, about 1 part by weight to about 10 parts by weight, based on 100 parts by weight of the barium titanate-based compound. When the plasticizer is mixed within the above content range, the dielectric slurry shows excellent dispersibility, and the amount of impurities included in the manufactured dielectric layer may be reduced.

The solvent may be an aqueous solvent such as water; an alcohol-based solvent such as ethanol, methanol, benzyl alcohol, and methoxyethanol; a glycol-based solvent such as ethylene glycol and diethylene glycol; a ketone-based solvent such as acetone, methyl ethyl ketone, methyl isobutyl ketone, and cyclohexanone; an ester-based solvent such as butyl acetate, ethyl acetate, carbitol acetate, and butylcarbitol acetate; an ether-based solvent such as methyl cellosolve, ethyl cellosolve, butyl ether, and tetrahydrofuran; an aromatic-based solvent such as benzene, toluene, and xylene, or the like. The solvent may be, for example, an alcohol-based solvent or aromatic-based solvent, considering solubility or dispersibility of various additives included in the dielectric slurry. The solvent may be mixed in an amount of about 50 parts by weight to about 1000 parts by weight, and for example, about 100 parts by weight to about 500 parts by weight based on 100 parts by weight of the barium titanate-based compound. When the solvent is mixed within the above content range, the dielectric slurry components may be sufficiently mixed, and subsequent removal of the solvent is easy.

The dielectric slurry described above may be mixed by using a wet ball mill or a stirred mill. When using the zirconia balls in the wet ball mill, a plurality of zirconia balls with a diameter of about 0.1 mm to about 10 mm may be used for wet mixing for about 8 hours to about 48 hours, or about 10 hours to about 24 hours.

The prepared dielectric slurry is formed into a dielectric layer after firing.

As a method of molding the prepared the dielectric slurry into a sheet shape, a tape molding method such as a doctor blade method, a calendar roll method, etc. may be used, for example, an on-roll molding coater with a head discharge method, and a dielectric green sheet may be obtained by drying the molded body afterward.

A conductive paste layer is formed by applying the conductive paste in a predetermined pattern on a surface of the dielectric green sheet using various printing methods such as screen printing or a transfer method.

Next, a dielectric green sheet stack is prepared by stacking a plurality of layers of dielectric green sheets on which internal electrode patterns are formed, and then pressing the plurality of layers of dielectric green sheets in the stacking direction. At this time, the dielectric green sheet and the internal electrode pattern may be stacked so that the dielectric green sheet is positioned on the upper and lower surfaces of the dielectric green sheet stack in the stacking direction.

The cutting of the manufactured dielectric green sheet stack to a predetermined size by dicing or the like may optionally be performed.

Additionally, the dielectric green sheet stack may be solidified and dried to remove plasticizers, etc., if necessary, and after solidified and dried, the dielectric green sheet stack may be barrel polished using a horizontal centrifugal barrel machine, and the like. In barrel polishing, the dielectric green sheet stack is placed into a barrel container with media and polishing liquid, and rotational motion or vibration is applied to the barrel container, thus unnecessary parts, such as burrs generated during cutting, may be polished. Additionally, after barrel polishing, the dielectric green sheet stack may be washed with a cleaning solution such as water, and dried.

Subsequently, the capacitor body may be manufactured after binder removal treatment and firing of the dielectric green sheet stack.

The conditions for binder removal may be appropriately adjusted depending on the components of the dielectric layer or the internal electrode layer. For example, the rate of temperature rise during binder removal treatment may be about 5° C./hour to about 300° C./hour, the support temperature may be about 180° C. to about 400° C., and the temperature holding time may be about 0.5 hour to about 24 hours. The binder removal may be performed under an air atmosphere or a reducing atmosphere.

The conditions of the firing treatment may be appropriately adjusted depending on the main component composition of the dielectric layer or the main component composition of the internal electrode layer. For example, the firing may be performed at a temperature of about 1100° C. to about 1400° C., for example, at a temperature of about 1200° C. to about 1350° C. Additionally, the firing may be performed for about 0.5 hour to about 8 hours, for example, about 1 hour to about 3 hours. Additionally, the firing may be performed in a reducing atmosphere, for example, in a humidified mixed gas of nitrogen and hydrogen. Additionally, the firing may be performed under oxygen partial pressure conditions of 10⁻¹² atm to 10⁻⁸ atm. When the firing is performed under the oxygen partial pressure conditions of the above range, a multilayer ceramic capacitor having high interfacial resistance between the dielectric layer and the internal electrode layer and excellent reliability can be obtained.

After firing, annealing may be performed as needed. The annealing is a treatment to re-oxidize the dielectric layer, and annealing may be performed if firing is performed in a reducing atmosphere. The conditions of the annealing treatment may also be appropriately adjusted depending on the components of the dielectric layer. For example, the annealing temperature may be about 950° C. to about 1150° C., the time may be about 0 to about 20 hours, and the rate of temperature rise may be about 50° C./hour to about 500° C./hour. The annealing atmosphere may be a humidified nitrogen gas (N₂) atmosphere, and an oxygen partial pressure may be about 1.0×10⁻⁹ MPa to about 1.0×10⁻⁵ MPa.

In binder removal treatment, firing treatment, or annealing treatment, for example, a wetter may be used to humidify nitrogen gas or mixed gas. In this case, the water temperature may be about 5° C. to about 75° C. The binder removal treatment, firing treatment, and annealing treatment may be performed sequentially or independently. Optionally, surface treatment such as sand blasting, laser irradiation, barrel polishing, etc. may be performed on the third and fourth surfaces of the prepare capacitor body 110. By performing this surface treatment, the ends of the first internal electrode layer and the second internal electrode layer may be exposed to the outermost surfaces of the third and fourth surfaces, and thus the electrical connection between the first external electrode layer and the second external electrode layer, and the first internal electrode and the second internal electrode may be improved, alloy portions may be easily formed.

Subsequently, the external electrode is formed on a surface of the manufactured capacitor body 110.

As an example, a paste for forming the sintered metal layer may be applied to the external electrode and then sintered to form the sintered metal layer.

The paste for forming the sintered metal layer may include a conductive metal and glass. Since the description of the conductive metal and glass is the same as described above, repetitive description will be omitted. Additionally, the paste for forming the sintered metal layer may optionally include a binder, solvent, dispersant, plasticizer, oxide powder, and the like. The binder may be, for example, ethylcellulose, acrylic, butyral, etc., and the solvent may be, for example, an organic solvent or aqueous solvent such as terpineol, butylcarbitol, alcohol, methyl ethyl ketone, acetone, toluene, and the like.

Methods for applying the paste for forming the sintered metal layer on the outer surface of the capacitor body 110 may include various printing methods such as dip method and screen printing, application method using a dispenser, etc., and spraying method using spray. The paste for forming the sintered metal layer may be applied to at least the third and fourth surfaces of the capacitor body 110, and optionally applied to a part of the first, second, fifth, or the sixth surfaces on which the band portions of the first and second external electrodes are formed.

Thereafter, the capacitor body 110 applied with the paste for forming the sintered metal layer is dried, and sintered at a temperature of about 700° C. to about 1000° C. for about 0.1 hour to about 3 hours, to form the sintered metal layer.

Optionally, a paste for forming the conductive resin layer is applied on an outer surface of the obtained capacitor body 110 and then cured, to form the conductive resin layer.

The paste for forming the conductive resin layer may include a resin and, optionally, a conductive metal or a non-conductive filler. Since the description of the conductive metal and resin is the same as described above, repetitive description will be omitted. Additionally, the paste for forming the conductive resin layer may optionally include a binder, a solvent, a dispersant, a plasticizer, an oxide powder, and the like. The binder may be, for example, ethylcellulose, acrylic, butyral, etc., and the solvent may be an organic solvent or aqueous solvent such as terpineol, butylcarbitol, alcohol, methyl ethyl ketone, acetone, and toluene.

For example, the conductive resin layer may be formed by dipping the capacitor body 110 in the paste for forming the conductive resin layer and then curing it, or by printing the paste for forming the conductive resin layer on the surface of the capacitor body 110 by a screen-printing method or a gravure printing method, or by applying the paste for forming the conductive resin layer to the surface of the capacitor body 110 and then curing it.

Next, a plating layer is formed on the outside of the conductive resin layer.

For example, the plating layer may be formed by a plating method, sputtering, or electrolytic plating (electric deposition).

Hereinafter, the embodiments are illustrated in more detail with reference to examples. However, these examples are exemplary, and the scope of claims is not limited thereto.

### (Manufacturing of Multilayer Ceramic Capacitors)

### Example 1

A conductive paste was prepared using a sulfur-containing nickel containing 1000 ppm of sulfur (S).

Next, a dielectric slurry was prepared using barium titanate (BaTiO₃) powder. At this time, the dielectric slurry was prepared by mechanical milling after adding ethanol/toluene, a dispersant, and a binder together using zirconia balls (ZrO₂ balls) as a dispersion medium.

Subsequently, the dielectric slurry was used by using a head discharge type on-roll forming coater to manufacture a dielectric green sheet. The conductive paste prepared above was printed on the surface of the dielectric green sheet to form a conductive paste layer.

The dielectric green sheets on which the conductive paste layers were formed were stacked and pressed to manufacture a dielectric green sheet stack.

Each dielectric green sheet stack was calcined at a temperature of 400° C. or less in a nitrogen atmosphere, and then heat-treated at 1100° C. to perform a desulfurization process. Subsequently, a firing was performed under the conditions of firing temperature of 1300° C. or less and hydrogen concentration of 1.0% or less, and oxygen partial pressure was controlled within the range of 10⁻¹² atm to 10⁻⁸ atm.

Next, external electrodes were formed to manufacture a multilayer ceramic capacitor.

### Example 2

A multilayer ceramic capacitor was manufactured in the same manner as in Example 1 except that the desulfurization process was performed by heat treatment at 1000° C.

### Example 3

A multilayer ceramic capacitor was manufactured in the same manner as in Example 1 except that the desulfurization process was performed by heat treatment at 1300° C.

### Example 4

A multilayer ceramic capacitor was manufactured in the same manner as in Example 1 except that the desulfurization process was performed by heat treatment at 1200° C.

### Comparative Example 1

A multilayer ceramic capacitor was manufactured in the same manner as in Example 1 except that the desulfurization process was not performed in Example 1.

### Evaluation 1: TEM-EDS Line Analysis

TEM-EDS (transmission electron microscopy-energy dispersive spectroscopy) line analysis was performed on the multilayer ceramic capacitors manufactured in Examples 1 to 4 and Comparative Example 1.

After the multilayer ceramic capacitor was placed into an epoxy mixing solution and then cured, the L-axis and the T-axis directional surface (LT surface) of the capacitor body was polished to ½ depth in the W-axis direction to expose a LT cross-section. A cross-sectional sample C, for observing the active region where the dielectric layer and the internal electrode layer overlap in the exposed LT cross-section, and a cross-sectional sample S, for observing the margin region located at one end of the active region in the L-axis direction (perpendicular to the stacking direction), are each obtained. Next, when the active region of the cross-sectional sample C was divided into three parts in the T-axis direction (stacking direction), the outer surface portions and the central portion located therebetween, each portion was measured by TEM under conditions of an acceleration voltage of 200 kV and a magnification of 79 k so that at least one dielectric layer and at least one internal electrode layer are visible. In addition, the margin region of the cross-sectional sample S was measured by TEM under conditions of an acceleration voltage of 200 kV and a magnification of 79 k so that at least one dielectric layer and at least one internal electrode layer were visible.

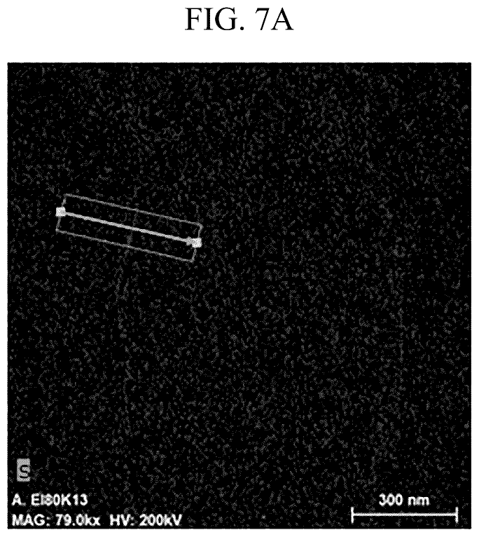

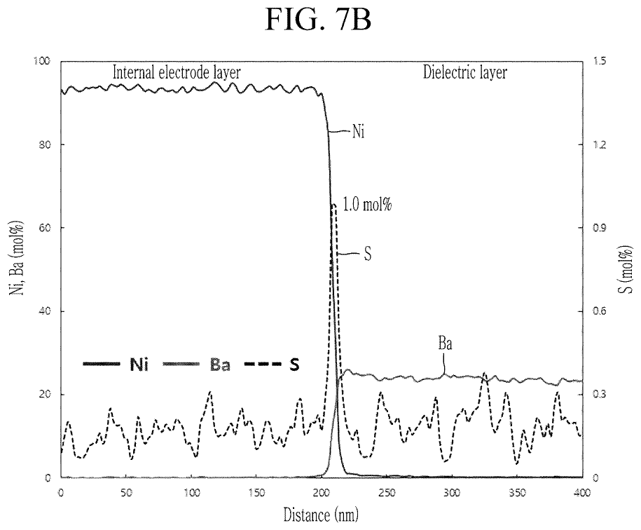

In each TEM image of the measured cross-sectional sample C and the TEM image of the cross-sectional sample S, EDS line analysis was performed on a straight section from a point of the internal electrode layer to a point of the dielectric layer adjacent to the internal electrode layer, and the results are shown in FIGS. 7 to 11 and Table 1 below.

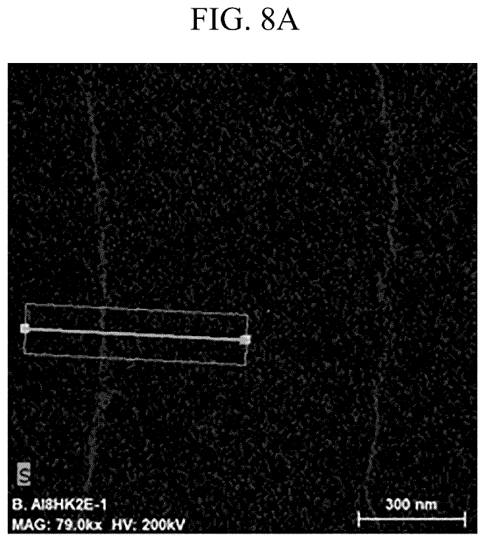

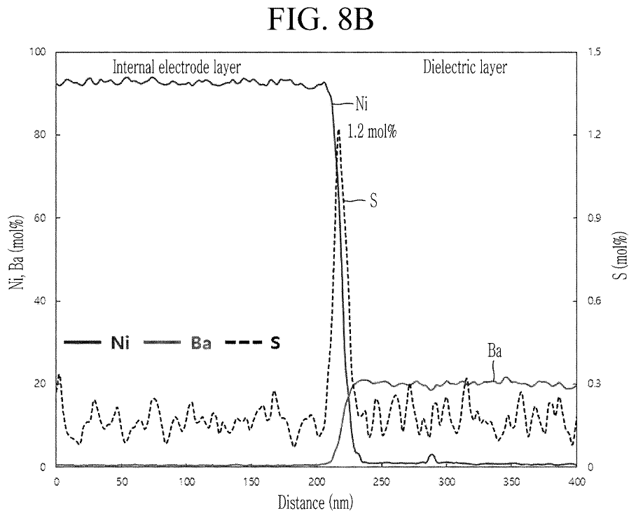

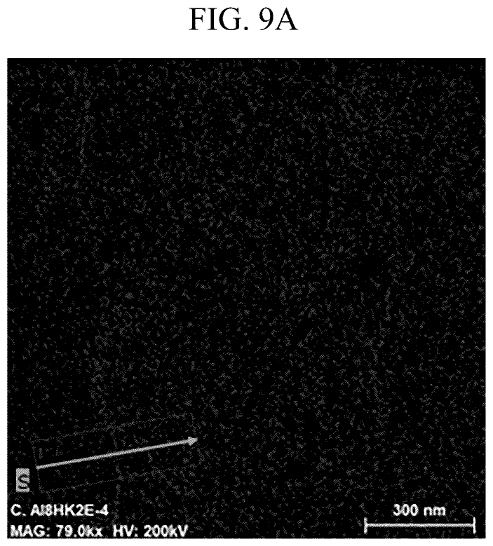

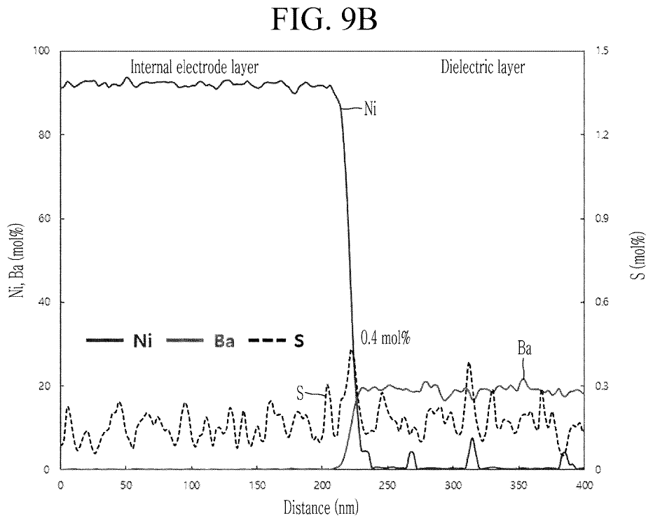

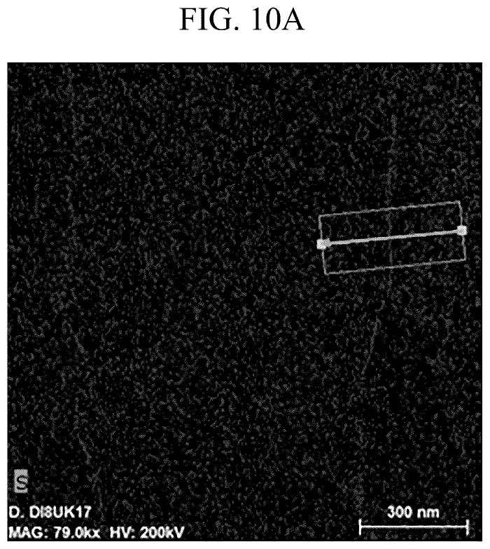

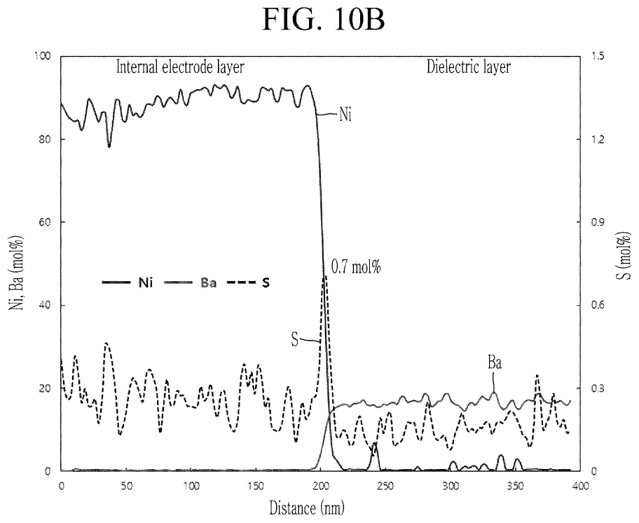

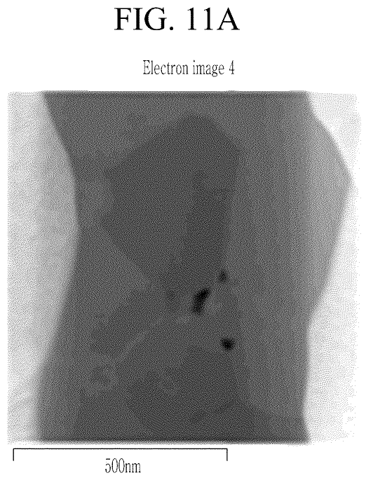

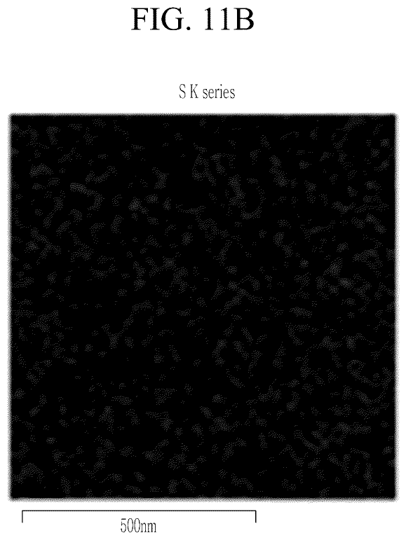

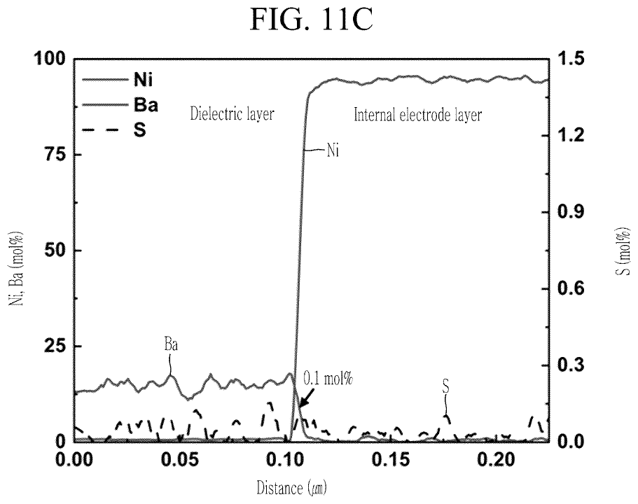

FIGS. 7A and 7B are transmission electron microscope-energy dispersive spectroscopy (TEM-EDS) line analysis image and graph for the internal electrode layer and the dielectric layer in the central portion of the active region according to Example 1, FIGS. 8A and 8B are transmission electron microscope-energy dispersive spectroscopy (TEM-EDS) line analysis image and graph for the internal electrode layer and the dielectric layer in the central portion of the active region according to Example 2, FIGS. 9A and 9B are transmission electron microscope-energy dispersive spectroscopy (TEM-EDS) line analysis image and graph for the internal electrode layer and the dielectric layer in the central portion of the active region according to Example 3, and FIGS. 10A and 10B are transmission electron microscope-energy dispersive spectroscopy (TEM-EDS) line analysis image and graph for the internal electrode layer and the dielectric layer in the central portion of the active region according to Example 4. FIGS. 11A to 11C are transmission electron microscope-energy dispersive spectroscopy (TEM-EDS) line analysis images and graph for the internal electrode layer and the dielectric layer in the margin region according to Example 1.

Referring to FIGS. 7A to 10B and Table 1 below, it can be seen that in the cases of Examples 1 to 4, sulfur (S) existed at the interface between the internal electrode layer and the dielectric layer in the central portion of the active region, that is, at the internal electrode layer interface region and the dielectric layer interface region. In addition, it can be seen that at least one of the internal electrode layer interface region and the dielectric layer interface region included sulfur (S) in an amount of 0.1 mol % or more and less than 2.0 mol % based on a total amount of elements present in each corresponding region. At this time, the S content was obtained by selecting three different sets of internal electrode layer and dielectric layer in the central portion of the active region, and designating three random points within the interface between the internal electrode layer and the dielectric layer for each set of internal electrode layer and dielectric layer, and taking the average value of the S content at a total of nine points.

In addition, according to the obtained EDS line analysis, in the central portion of the active region, the internal electrode layer interface region was confirmed as a region from a point that is about ½ of a maximum mol % of nickel (Ni) to about 9/10 of the maximum mol % of nickel (Ni) based on a total amount of elements present in the same region, and the dielectric layer interface region was confirmed as a region from a point that is about ½ of a maximum mol % of nickel (Ni) to about ¼ of the maximum mol % of nickel (Ni) based on a total amount of elements present in the same region.

Also, referring to FIGS. 11A to 11C, in the case of Example 1, it can be seen that sulfur (S) existed not only at the interface between the internal electrode layer and the dielectric layer in the central portion of the active region, but also at the interface between the internal electrode layer and the dielectric layer in the margin region, that is, at the internal electrode layer interface region and the dielectric layer interface region. In addition, it can be seen that at least one of the internal electrode layer interface region and the dielectric layer interface region included sulfur (S) in an amount of more than 0 to 1.0 mol % or less based on a total amount of elements present in each corresponding region. At this time, the S content was obtained by selecting three different sets of internal electrode layer and dielectric layer in the margin region, and designating three random points within the interface between the internal electrode layer and the dielectric layer for each set of internal electrode layer and dielectric layer, and taking the average value of the S content at a total of nine points.

In addition, according to the obtained EDS line analysis, in the margin region, the internal electrode layer interface region was confirmed as a region from a point that is about ½ of a maximum mol % of nickel (Ni) to a point that is about 9/10 of the maximum mol % of nickel (Ni) based on a total amount of elements present in the same region, and the dielectric layer interface region was confirmed as a region from a point that is about ½ of a maximum mol % of nickel (Ni) to a point that is about 1/10 of a maximum mol % of nickel (Ni) based on a total amount of elements present in the same region.

In Table 1 below, the interface between the internal electrode layer and the dielectric layer represents at least one of an internal electrode layer interface region within the internal electrode layer and a dielectric layer interface region within the dielectric layer. Additionally, the S content (mol %) is expressed based on a total amount of elements present in each corresponding region.

TABLE 1

| | S content (mol %) at the interface |
|---|---|
| | between the internal electrode layer |
| | and the dielectric layer in the central |
| | portion of the active region |
| Example 1 | 1.0 |
| Example 2 | 1.2 |
| Example 3 | 0.4 |
| Example 4 | 0.7 |
| Comparative | 2.0 |
| Example 1 | |

### Evaluation 2: Microstructures of Internal Electrode Layer

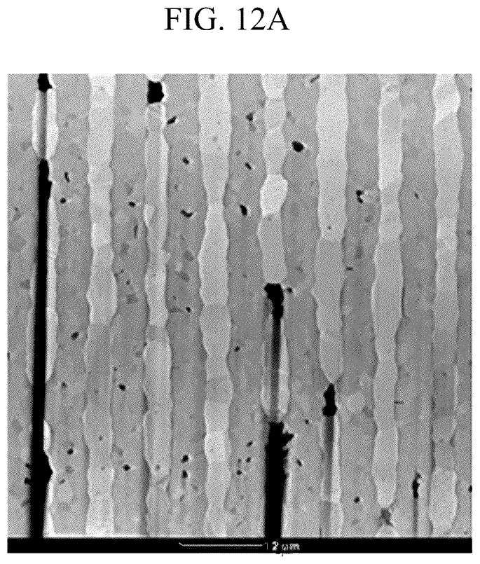

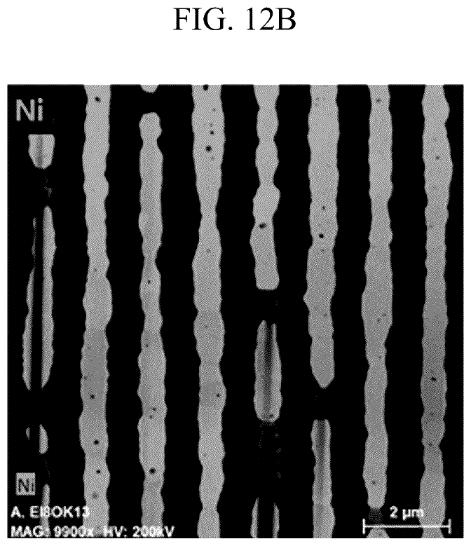

TEM-EDS (transmission electron microscopy-energy dispersive spectroscopy) analysis was performed on the multilayer ceramic capacitor manufactured in Example 2, and the results are shown in FIGS. 12A and 12B.

EDS analysis was performed on the TEM image of the central portion of the active region for the cross-sectional sample C obtained in Evaluation 1.

FIGS. 12A and 12B are TEM-EDS (transmission electron microscopy-energy dispersive spectroscopy) analysis images of the central portion of the active region according to Example 2.

Referring to FIGS. 12A and 12B, it can be seen that in the case of Example 2, the microstructures of the internal electrode layer is improved, resulting in excellent connectivity of the internal electrode layer.

### Evaluation 3: Electric Characteristic

A capacitance and a breakdown voltage were measured for the multilayer ceramic capacitors manufactured in Examples 1 to 4 and Comparative Example 1, and the results are shown in Table 2 below.

The capacitance was measured under the conditions of frequency 1 kHz and voltage 0.5 V. In Table 2 below, the capacitance is expressed as a percentage of a reference capacitance of 220 μF.

The breakdown voltage (BDV) was measured for each multilayer ceramic capacitor at room temperature (25° C.) under a 100 V/s step-up condition, and was measured as the voltage value when the insulation resistance (IR) value fell below 10000Ω.

### Evaluation 4: Reliability

The MTTF (mean time to failure) was measured for the multilayer ceramic capacitors manufactured in Examples 1 to 4 and Comparative Example 1 by the following method, and the results are shown in Table 2 below.

MTTF (mean time to failure) was measured under the conditions of temperature 125° C., voltage 6V, and 48 hours to obtain the average failure time (hr) value.

TABLE 2

| | S content (mol %) at | | | |
|---|---|---|---|---|
| | the interface between | | | |
| | the internal electrode | | | |
| | layer and the dielectric | | | |
| | layer in the central | | | |
| | portion of the active | capacitance | | |
| | region | (%) | BDV(V) | MTTF |
| Example 1 | 1.0 | 122.32 | 64.2 | 278.3 |
| Example 2 | 1.2 | 125.97 | 66.0 | 315.2 |
| Example 3 | 0.4 | 109.34 | 52.5 | 150.2 |
| Example 4 | 0.7 | 115.63 | 53.7 | 201.7 |
| Comparative | 2.0 | 99.24 | 48.4 | 88.5 |
| Example 1 | | | | |

Referring to Table 2 above, it can be seen that Examples 1 to 4 have superior electrical characteristics and reliability compared to Comparative Example 1. From this, it can be confirmed that, according to an embodiment, sulfur (S) exists at the interface between the internal electrode layer and the dielectric layer in locations of the central portion of the active region and at least one of i) the surface portions of the active region and ii) the margin regions, and the content of sulfur (S) present at the interface between the internal electrode layer and the dielectric layer in the central portion of the active region is controlled to about 0.1 mol % or more and less than about 2.0 mol %, thereby providing excellent electrical characteristics and reliability.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A multilayer ceramic capacitor, comprising
a capacitor body including a dielectric layer and an internal electrode layer, and
an external electrode disposed on an outer surface of the capacitor body,
wherein the capacitor body comprises an active region in which the dielectric layer and the internal electrode layer are stacked in a stacking direction, and a margin region disposed on sides of the active region opposing each other in a direction perpendicular to the stacking direction,
the active region includes three portions in the stacking direction,
the three portions include a central portion, and a surface portion located on both surfaces of the central portion, and
the internal electrode layer comprises an internal electrode layer interface region including an interface with the dielectric layer, and the dielectric layer comprises a dielectric layer interface region including an interface with the internal electrode layer, and
wherein at least one of the internal electrode layer interface region or the dielectric layer interface region located in the central portion of the active region comprises sulfur (S), and
at least one of the internal electrode layer interface region or the dielectric layer interface region located in at least one of the surface portion of the active region or the margin region comprises sulfur (S).

2. The multilayer ceramic capacitor of claim 1, wherein
the at least one of the internal electrode layer interface region or the dielectric layer interface region located in the central portion of the active region comprises the sulfur (S) in an amount of 0.1 mol % or more and less than 2.0 mol % based on a total amount of elements present in each corresponding region in the central portion of the active region.

3. The multilayer ceramic capacitor of claim 1, wherein
the at least one of the internal electrode layer interface region or the dielectric layer interface region located in the central portion of the active region further comprises nickel (Ni), and
in a transmission electron microscope-energy dispersive spectroscopy (TEM-EDS) line analysis of a straight section from a point of the internal electrode layer to a point of the dielectric layer adjacent to the internal electrode layer in the central portion of the active region,
the internal electrode layer interface region in the central portion of the active region is a region from a point that is ½ of a maximum mol % of nickel (Ni) to a point that is 9/10 of the maximum mol % of nickel (Ni) based on a total amount of elements present in the same region.

4. The multilayer ceramic capacitor of claim 1, wherein
the at least one of the internal electrode layer interface region or the dielectric layer interface region located in the central portion of the active region further comprises nickel (Ni), and
in a transmission electron microscope-energy dispersive spectroscopy (TEM-EDS) line analysis of a straight section from a point of the internal electrode layer to a point of the dielectric layer adjacent to the internal electrode layer in the central portion of the active region,
the dielectric layer interface region in the central portion of the active region is a region from a point that is ½ of a maximum mol % of nickel (Ni) to a point that is ¼ of the maximum mol % of nickel (Ni) based on a total amount of elements present in the same region.

5. The multilayer ceramic capacitor of claim 1, wherein
the at least one of the internal electrode layer interface region or the dielectric layer interface region located in the central portion of the active region comprises the sulfur (S) in an amount of 0.1 mol % to 1.2 mol % based on a total amount of elements present in each corresponding region in the central portion of the active region.

6. The multilayer ceramic capacitor of claim 1, wherein
the at least one of the internal electrode layer interface region or the dielectric layer interface region located in at least one of the surface portion of the active region or the margin region comprises the sulfur (S) in an amount of more than 0 mol % and 1.0 mol % or less based on a total amount of elements present in each corresponding region in the at least one of the surface portion of the active region or the margin region.

7. The multilayer ceramic capacitor of claim 1, wherein
the at least one of the internal electrode layer interface region or the dielectric layer interface region located in at least one of the surface portion of the active region or the margin region further comprises nickel (Ni), and
in a transmission electron microscope-energy dispersive spectroscopy (TEM-EDS) line analysis of a straight section from a point of the internal electrode layer to a point of the dielectric layer adjacent to the internal electrode layer in at least one of the surface portion of the active region or the margin region,
the internal electrode layer interface region in at least one of the surface portion of the active region or the margin region is a region from a point that is ½ of a maximum mol % of nickel (Ni) to a point that is 9/10 of the maximum mol % of nickel (Ni) based on a total amount of elements present in the same region.

8. The multilayer ceramic capacitor of claim 1, wherein
the at least one of the internal electrode layer interface region or the dielectric layer interface region located in at least one of the surface portion of the active region or the margin region further comprises nickel (Ni), and
in a transmission electron microscope-energy dispersive spectroscopy (TEM-EDS) line analysis of a straight section from a point of the internal electrode layer to a point of the dielectric layer adjacent to the internal electrode layer in at least one of the surface portion of the active region or the margin region,
the dielectric layer interface region in at least one of the surface portion of the active region or the margin region is a region from a point that is ½ of a maximum mol % of nickel (Ni) to a point that is 1/10 of the maximum mol % of nickel (Ni) based on a total amount of elements present in the same region.

9. A multilayer ceramic capacitor, comprising
a capacitor body including a dielectric layer and an internal electrode layer, and
an external electrode disposed on an outer surface of the capacitor body,
wherein the capacitor body comprises an active region in which the dielectric layer and the internal electrode layer are stacked in a stacking direction, and a margin region disposed on sides of the active region opposing each other in a direction perpendicular to the stacking direction,
the active region includes three portions in the stacking direction,
the three portions include a central portion, and a surface portion located on both surfaces of the central portion, and
wherein in the central portion of the active region, at least one of (i) a first region from an interface between the internal electrode layer and the dielectric layer to a depth of 15 nm to 25 nm from the interface into an interior of the internal electrode layer, or (ii) a second region from the interface to a depth of 15 nm to 25 nm from the interface into an interior of the dielectric layer comprises sulfur (S), and
in at least one of the surface portion of the active region or the margin region, at least one of (i) a third region from the interface to a depth of 5 nm to 15 nm from the interface into the interior of the internal electrode layer, or (ii) a fourth region from the interface to a depth of 5 nm to 15 nm from the interface into the interior of the dielectric layer comprises sulfur (S).

10. The multilayer ceramic capacitor of claim 9, wherein
in the central portion of the active region, at least one of the first region or the second region comprises the sulfur (S) in an amount of 0.1 mol % or more and less than 2.0 mol % based on a total amount of elements present in each corresponding region.

11. The multilayer ceramic capacitor of claim 9, wherein
in the central portion of the active region, at least one of the first region or the second region comprises the sulfur (S) in an amount of 0.1 mol % to 1.2 mol % based on a total amount of elements present in each corresponding region.

12. The multilayer ceramic capacitor of claim 9, wherein
in at least one of the surface portion of the active region or the margin region, at least one of the third region or the fourth region comprises the sulfur (S) in an amount of more than 0 mol % and 1.0 mol % or less based on a total amount of elements present in each corresponding region.

13. A method of manufacturing the multilayer ceramic capacitor according to claim 1, comprising
preparing a conductive paste using a sulfur-containing nickel;
manufacturing a plurality of dielectric green sheets from a dielectric slurry, and printing the conductive paste on a surface of the plurality of dielectric green sheets to form a conductive paste layer;
manufacturing a dielectric green sheet stack by stacking the plurality of dielectric green sheets on which the conductive paste layer is formed;
performing a heat treatment on the dielectric green sheet stack to desulfurize the sulfur-containing nickel;
manufacturing the capacitor body by firing the dielectric green sheet stack after the heat treatment; and
forming the external electrode on the outer surface of the capacitor body.

14. The method of claim 13, wherein
the sulfur-containing nickel has a form in which sulfur (S) is coated on the surface of nickel (Ni).

15. The method of claim 13, wherein
the sulfur-containing nickel comprises 100 ppm to 2000 ppm of sulfur (S).

16. The method of claim 13, wherein
the heat treatment is performed at a temperature of 900° C. to 1500° C.

17. The method of claim 13, wherein
the heat treatment is performed for 0.01 hours to 2.0 hours.

18. A multilayer ceramic capacitor, comprising
a capacitor body including a dielectric layer and an internal electrode layer, and
an external electrode disposed on an outer surface of the capacitor body,
wherein the capacitor body comprises an active region in which the dielectric layer and the internal electrode layer are stacked in a stacking direction, and a margin region disposed on sides of the active region opposing each other in a direction perpendicular to the stacking direction,
the active region includes three portions in the stacking direction,
the three portions include a central portion, and a surface portion located on both surfaces of the central portion, and
the dielectric layer comprises a dielectric layer interface region including an interface with the internal electrode layer, and
wherein (i) the dielectric layer interface region located in the central portion of the active region comprises sulfur (S), (ii) the dielectric layer interface region located in at least one of the surface portion of the active region or the margin region comprises sulfur (S), or both (i) and (ii).

19. The multilayer ceramic capacitor of claim 18, wherein
the dielectric layer interface region located in the central portion of the active region comprises the sulfur (S) in an amount of 0.1 mol % or more and less than 2.0 mol % based on a total amount of elements present in the same region.

20. The multilayer ceramic capacitor of claim 18, wherein
the dielectric layer interface region located in the central portion of the active region further comprises nickel (Ni), and
in a transmission electron microscope-energy dispersive spectroscopy (TEM-EDS) line analysis of a straight section from a point of the internal electrode layer to a point of the dielectric layer adjacent to the internal electrode layer in the central portion of the active region,
the dielectric layer interface region in the central portion of the active region is a region from a point that is ½ of a maximum mol % of nickel (Ni) to a point that is ¼ of the maximum mol % of nickel (Ni) based on a total amount of elements present in the same region.

21. The multilayer ceramic capacitor of claim 18, wherein
the dielectric layer interface region located in at least one of the surface portion of the active region or the margin region further comprises nickel (Ni), and
in a transmission electron microscope-energy dispersive spectroscopy (TEM-EDS) line analysis of a straight section from a point of the internal electrode layer to a point of the dielectric layer adjacent to the internal electrode layer in at least one of the surface portion of the active region or the margin region,
the dielectric layer interface region in at least one of the surface portion of the active region or the margin region is a region from a point that is ½ of a maximum mol % of nickel (Ni) to a point that is 1/10 of the maximum mol % of nickel (Ni) based on a total amount of elements present in the same region.
